(19) United States
(12) Patent Application Publication
(10) Pub. No.: US 2026/0229394 A1
(43) Pub. Date: Aug. 6, 2026

(54) MAGNETIC THIN FILM PROCESS CHAMBER DESIGN FOR HIGH-DENSITY POWER CONVERTERS

(71) Applicants: Applied Materials, Inc., Santa Clara, CA (US); The Florida International University Board of Trustees, Miami, FL (US)

(72) Inventors: Mudit Sunilkumar KHASGIWALA, Milpitas, CA (US); Arvin KHOSRAVI, Los Gatos, CA (US); Subramani KENGERI, Saratoga, CA (US); Markondeyaraj PULUGURTHA, Miami, FL (US); Mohammad Mohtasim Hamid PIAL, Miami, FL (US)

(73) Assignees: Applied Materials, Inc., Santa Clara, CA (US); The Florida International University Board of Trustees, Miami, FL (US)

(21) Appl. No.: 19/045,289

(22) Filed: Feb. 4, 2025

(51) Int. Cl. H01F 17/06; H01F 27/28; H01F 41/02; H01F 41/14

(52) U.S. Cl. CPC H01F 17/06; H01F 27/2847; H01F 41/022; H01F 41/14

(57) ABSTRACT

A toroidal inductor may include a substrate. The toroidal inductor may also include a magnetic film deposited on the substrate during a manufacturing process, wherein the substrate is exposed to one or more magnetic fields creating local and/or spatially-variant anisotropy. The toroidal inductor may also include one or more metal windings deposited on the substrate corresponding to the spatially-variant anisotropy.

### FIELD OF THE INVENTION

This disclosure relates to semiconductor manufacturing. Specifically, this disclosure relates to manufacturing integrated passive devices.

### BACKGROUND

Power delivery networks (PDNs) are reliant on high levels of inductive density for components within the PDNs. As computational demands grow, so does the need for higher performing components in order to provide power efficiently and smoothly to various processors. However, components that perform to both modern and future standards may be limited by current manufacturing techniques. Thus, improved systems and techniques for manufacturing various components is needed.

### BRIEF SUMMARY

A toroidal inductor may include a substrate. The toroidal inductor may also include a magnetic film deposited on the substrate during a manufacturing process, wherein the substrate is exposed to one or more magnetic fields creating local and/or spatially-variant anisotropy. The toroidal inductor may also include one or more metal windings deposited on the substrate corresponding to the spatially-variant anisotropy.

In some embodiments, the toroidal inductor may include a cobalt-zirconium-tantalum (CZT) layer. A current density of the toroidal inductor is in a range of 1-5 A/mm2, inclusive. The substrate may include silicon. The locally variant anisotropy may be generated at least in part by a magnetic grid.

A method of forming semiconductor devices may include generating a device layout plan including locations on a substrate to be formed into respective semiconductor devices. The method may include providing the substrate on a platform of a semiconductor processing chamber. The method may include providing a jig underneath the platform of the semiconductor processing chamber, the jig including one or more magnets placed on the jig according to the device layout plan. The method may include depositing a magnetic film on the substrate. The method may include depositing a metal layer on the magnetic film such that the respective semiconductor devices are formed at the locations on the substrate according to the device layout plan, where the locations on the substrate experiences a radially anisotropic magnetic field from at least one of the one or more magnets. The method may include dicing the substrate according to the device layout plan such that the respective semiconductor devices are formed.

In some embodiments, the magnetic fields may be within a range of 0.25 T to 1.25 T, inclusive. The magnetic fields of adjacent magnets of the one or more magnets may include alternating polarity. The method may include forming a magnetic film on the substrate. The magnetic film may be used as a blanket unpatterned film. The magnetic film may be patterned as circular or rectangular frames. The one or more magnets include at least one or neodymium, iron boron, samarium cobalt, or Alnico.

A semiconductor manufacturing jig may include a bottom surface. The jig may include a plurality of vertical partitions, attached to the bottom surface and defining one or more recesses corresponding to locations of semiconductor devices to be formed according to a device layout plan. The jig may include one or more magnets disposed in respective spaces of the one or more spaces corresponding to locations of semiconductor devices according to a device layout plan. The one or more magnets may produce respective magnetic fields on a substrate placed on the plurality of vertical partitions, the respective magnetic fields corresponding to the locations of the semiconductor devices to be formed.

In some embodiments, the respective magnetic fields may produce local anisotropy at each of the locations of semiconductor devices to be formed on the substrate. The respective magnetic fields may produce radial anisotropy at each of the locations of semiconductor devices to be formed on the substrate. The one or more magnets may have a Curie temperature of at least 200° C. The one or more magnets may be cylindrical. The one or more magnets may be hollow. The one or magnets may be arranged in the jig coaxially. The one or magnets may be arranged in the jig such that polarities of adjacent magnets are different.

### BRIEF DESCRIPTION OF THE DRAWINGS

FIG. 1 shows a top plan view of one embodiment of a processing system of deposition, etching, baking, and/or curing chambers according to some embodiments.

FIG. 2 illustrates a flowchart of a method of forming semiconductor devices, according to certain embodiments.

FIGS. 3A-3I illustrate a substrate and jig for manufacturing semiconductor devices, according to certain embodiments.

FIG. 4 illustrates a toroidal inductor with six windings, according to certain embodiments.

FIG. 5 illustrates an exemplary computer system 500, in which various embodiments may be implemented.

### DETAILED DESCRIPTION OF THE INVENTION

Efficient power delivery to for artificial intelligence (AI) and other and high-performance computing applications is of increasing importance in order to facilitate more powerful AI engines. Beyond efficiency, however, other power delivery characteristics are also important. Some of these characteristics may include higher computer bandwidth at lower power, energy savings, improved reliability, reduced bill of materials, and supply chain independence or

### Simplicity.

Power delivery improvements may be made via energy storage components such as inductors and capacitors. The storage density, frequency, and voltage or current-handling capability directly translates to the power density output by power delivery networks of semiconductor packages/devices, typically measured in Watts per mm² (W/mm²) or Amperes per mm² (A/mm²). In order for an integrate passive device (IPD) (i.e., an inductor) to reach 5 A/mm², the IPD must also have a high inductive density, high current handling capabilities, and be able to operate at high frequencies (e.g., greater than 1000 MHz).

One way of achieving the above goals/performance metrics may include manufacturing devices using layers of thin magnetic films such as Cobalt-Zirconium-Tantalum (CZT) with interspersed oxide layers for suppressing eddy currents on the films. The magnetic films may also have high FMR (ferromagnetic resonance) to attain frequency stability beyond 1000 MHz. The films may be formed or otherwise applied to silicon wafers, then have metal coils sputtered (or otherwise deposited) in order to form inductors. These inductors may have smaller magnetic core thicknesses compared to standard inductors, achieving current handling and inductive density goals. However, achieving the inductive density goals (and other electrical characteristics) may require more windings. The more windings and inductor has more resistance the higher coil resistance and thus lower efficiency. Furthermore, thickness scaling constraints may limit the efficient (both in ease of manufacturing and in cost) of high performing inductors (i.e., high inductive density and current handling).

There are several approaches to create such inductors by creating radial magnetic anisotropy during a deposition process. One approach is to provide a fixture above a wafer (or substrate) that includes copper windings to generate radial magnetic fields at the wafer. The copper windings may match a semiconductor device layout of the wafer. The windings from the fixture may be aligned with the device wafer. Current may be applied to the fixture, generating the radial magnetic fields at the wafer. A limitation of this approach arises because the fixture may require 1000s of coils be powered with high currents (approximately 1 A) to generate the flux concentration to generate radial anisotropy. Such currents may generate excess heat and create issues with thermal management and power supply, leading to poor reliability and high expense during the manufacturing process. In another approach, post-annealing is performed to achieve radial anisotropy. The aligned system (e.g., wafer etc.) is placed in a vacuum oven at elevated temperatures (~300 °C.) so that permanent magnetic orientation is created in the radial axis of a location on the wafer corresponding to a desired device. However, the amorphous nanostructure is disturbed as coarse crystallites are formed during the annealing process. The coarse crystallites may have extremely high surface anisotropy, leading to poor reliability of devices created by this process.

It may be beneficial to achieve “local and spatially-distributed” anisotropy during sputtering. Current sputtering processes may achieve unidirectional anisotropy. This provides limited performance opportunities for the resulting inductors, transformers etc. By introducing a coaxial or rectangular grid as a jig under the substrate holder, we may create local and spatially-distributed anisotropy. The jig may be designed such that the local anisotropy distribution is spatially varied to match well with the coil topology. For example, if the coils create a circular magnetic field, radial anisotropy may be beneficial. If the coils create a square toroid of windings, local anisotropy with “hard axis” properties along the four arms of the coils may be formed.

A solution may be to provide a specialized jig with magnetic fixtures that impose magnetic radial anisotropy at a substrate. A device layout plan may be generated where locations may be mapped to a substrate. Each of the locations may correspond to a semiconductor device to be formed (e.g., an inductor, coupled inductor, transformer, multiphase inductors, and/or other such device). Then, the substrate may be provided to a semiconductor processing chamber on a platform. A jig may be provided beneath the platform. The jig may include one or more magnets placed within the jig in according to the device layout plan. The one or more magnets may cause magnetic fields to extend through the platform and the substrate, cause magnetic local anisotropy. A metal may then be deposited on the substrate to create the semiconductor devices on the substrate according to the device layout plan. The substrate may then be diced in order to form the semiconductor devices. By creating the semiconductor devices in this manner, the devices may have high inductive density, while minimizing resistance and other unwanted electrical effects. Furthermore, because the techniques and systems described herein do not require large currents or annealing, downsides to other approaches may be avoided.

The jig may adjust the local magnetic field patterns during deposition. The deposited film may have local anisotropy that might be beneficial when the coils are designed around the film. For example, the coils may be designed such that the resulting magnetic field from the inductor current can be along the “hard axis” of the deposited film. The deposited film may then have a field orientation that can maximize current-handling and minimize coercivity along the whole coil path.

Deposited films may be left as blanket films and not patterned as toroids (circular frames) or rectangular frames. Blanket films may be able to handle more magnetic field density by effective field distribution. Blanket films may thus be good for higher current handling and power handling. If blanket films are used, the coils can be stitched in spatially optimized pattern to maximize the benefit from local anisotropy.

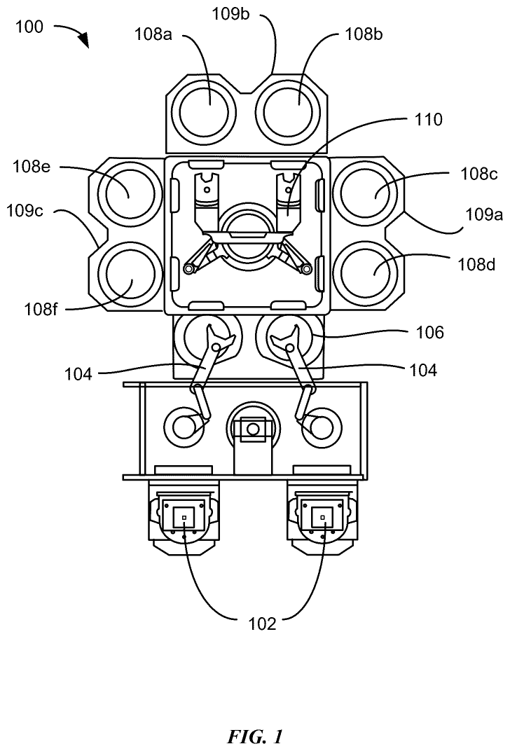

FIG. 1 shows a top plan view of one embodiment of a processing system 100 of deposition, etching, baking, and/or curing chambers according to some embodiments. In the figure, a pair of front opening unified pods 102 may supply substrates of a variety of sizes that are received by robotic arms 104 and placed into a low pressure holding area 106 before being placed into one of the substrate processing chambers 108a-f, positioned in tandem sections 109a-c. A second robotic arm 110 may be used to transport the substrate wafers from the holding area 106 to the substrate processing chambers 108a-f and back. Each substrate processing chamber 108a-f, can be outfitted to perform a number of substrate processing operations including the dry etch processes described herein in addition to cyclical layer deposition, atomic layer deposition, chemical vapor deposition, physical vapor deposition, etch, pre-clean, degas, orientation, and other substrate processes.

The substrate processing chambers 108a-f may include one or more system components for depositing, annealing, curing and/or etching a dielectric, metal, or semiconductor film on the substrate wafer. In one configuration, two pairs of the processing chambers, e.g., 108c-d and 108e-f, may be used to deposit dielectric material on the substrate, and the third pair of processing chambers, e.g., 108a-b, may be used to etch the deposited material. In another configuration, all three pairs of chambers, e.g., 108a-f, may be configured to etch a dielectric, metal, or semiconductor material on the substrate. Any of the tandem sections may be outfitted with processing systems described below. It will be appreciated that additional configurations of deposition, etching, annealing, and curing chambers for dielectric films are similarly encompassed by system 100.

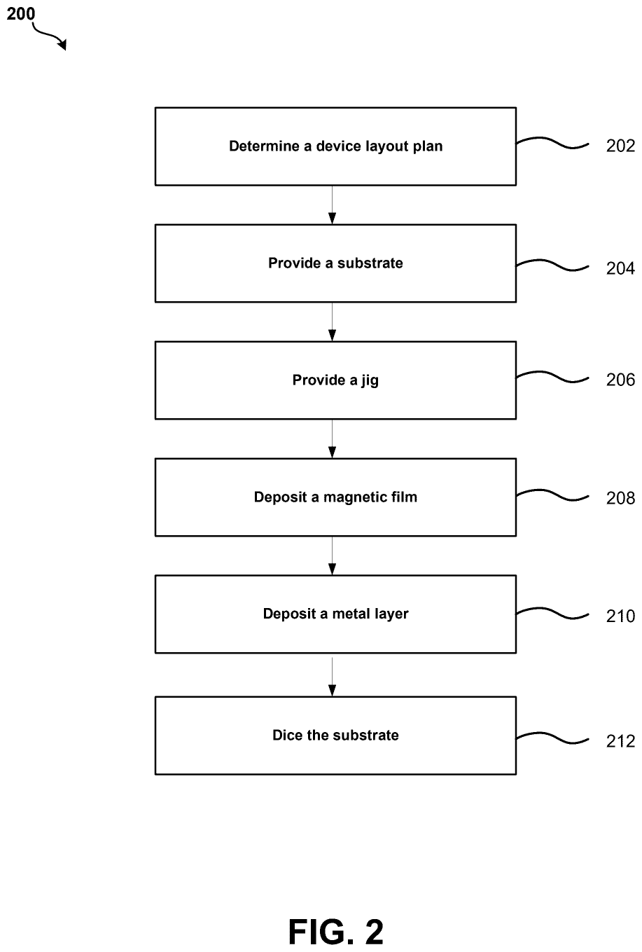

FIG. 2 illustrates a flowchart of a method 200 of forming semiconductor devices, according to certain embodiments. Steps of the method 200 may be performed in a different order than is shown and described here. The steps of the method 200 may additionlly or alternatively be combined with other steps. In some embodiments, some steps may be skipped altogether.

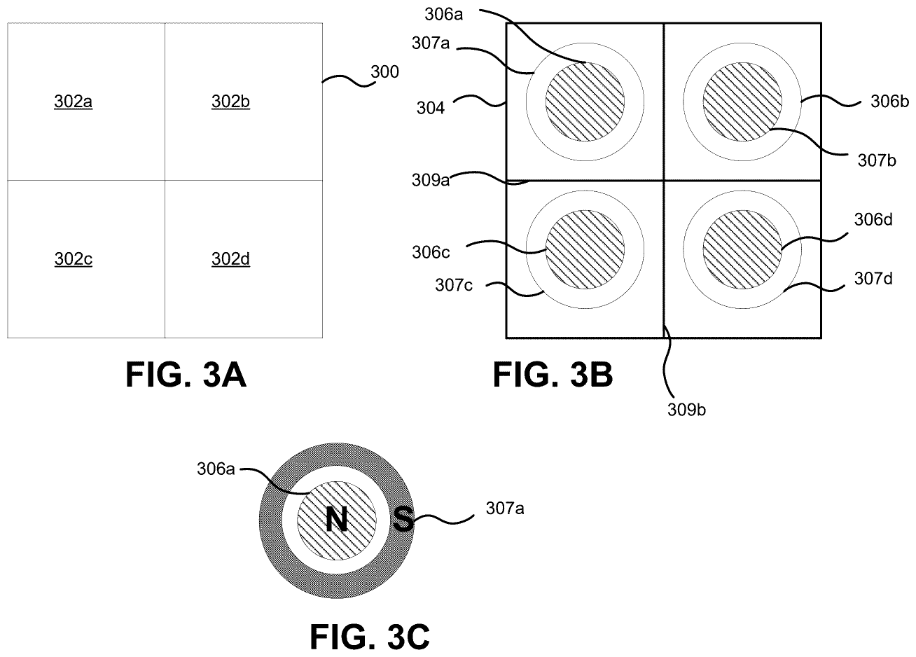

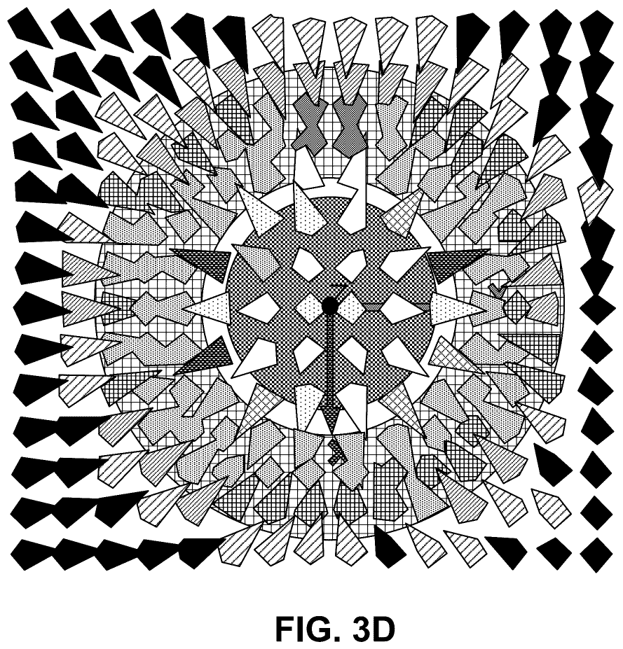

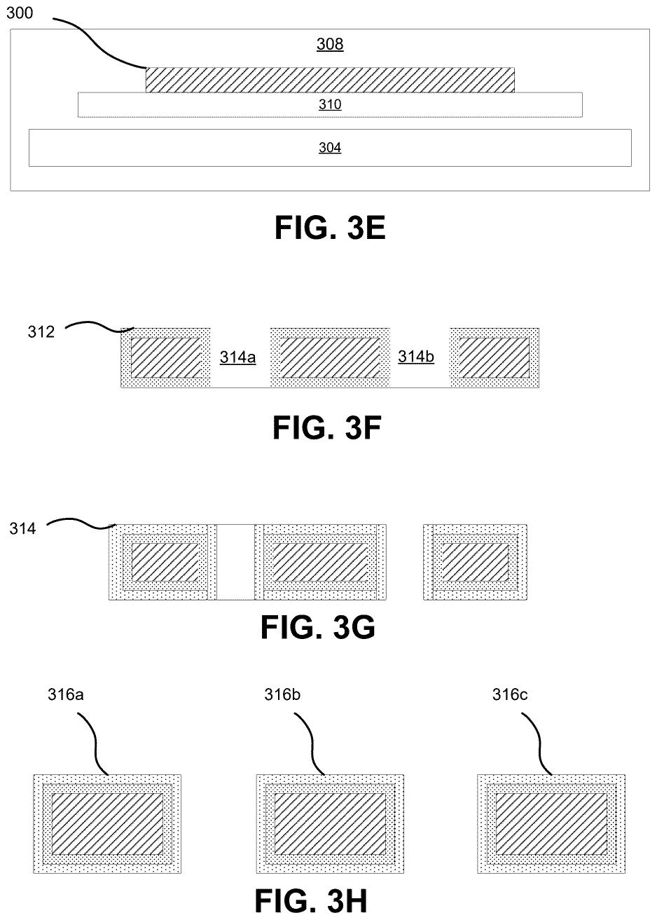

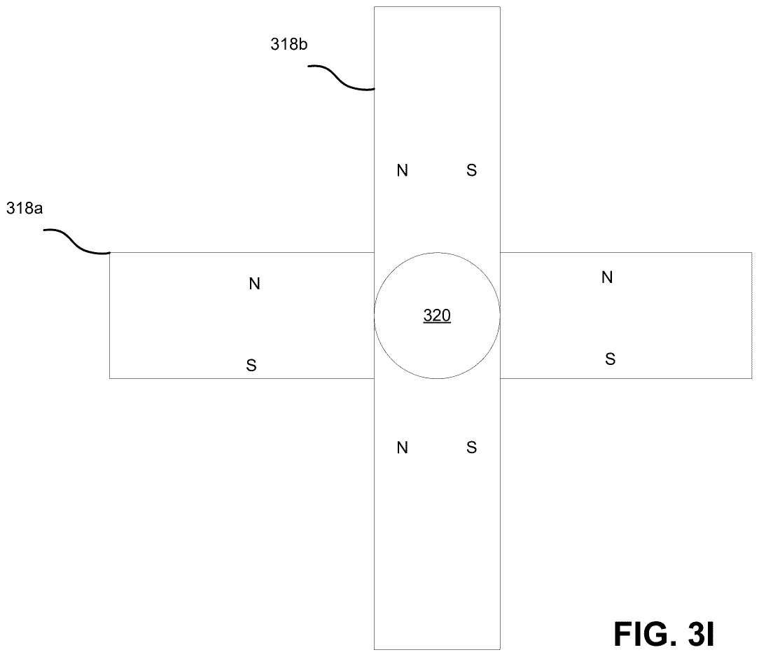

At step 202, the method 200 may include generating a device layout plan including locations on a substrate 300 to be formed into respective semiconductor devices, as shown in FIG. 3A. The substrate 300 may be a silicon wafer, flexible core (e.g., including polyimide, glass, liquid crystal polymer, fluoropolymer, Molypermalloy powder cores, High Flux, kool Mu®/Sendust, etc.) or any other suitable material. The substrate 300 may also include locations 302a-d corresponding to various semiconductor devices to be formed. For example, the device layout plan may indicate that locations 302a-d may indicate that IPDs such as inductors are to be formed at each those locations. In other examples, some of the locations 302a-d may not have devices formed, or may have other types of devices.

Then, a jig 304 may be formed according to the device layout plan. FIG. 3B illustrates a top-down view of the jig 304 with first magnets 306a-d and second magnets 307a-d, according to certain embodiments. The jig 304 may include a bottom surface and vertical partitions 309a-b. The vertical partitions 309a-b may define recesses corresponding to the locations 302a-d of the device layout plan and/or the substrate 300. The first magnets 306a-d and the second magnets 307a-d may be disposed within the recesses.

As seen in FIG. 3C, the first magnet 306a and the second magnet 307a may both be cylindrical magnets, arranged about a common axis. The first magnet 306a may be a solid cylinder including materials such as neodymium, iron, boron, alnico, samarium cobalt, or any other suitable material. The first magnet 306a a may include a height (into the page in FIG. 3C) within a range of 0.25 mm to 2 mm, inclusive. In some embodiments, the first magnet 306a may include a height of 1 mm. The first magnet 306a may include a diameter within a range of 0.5 mm to 2 mm, inclusive. In some embodiments, the first magnet 306a may have a diameter of 1 mm. The first magnet 306a may include a Curie temperature within a range of about 180° C. to about 225° C. In some embodiments, the first magnet 306a may include a Curie temperature of 200° C. or greater.

The second magnet 307a may be a hollow cylinder including materials such as neodymium, iron, boron, alnico, samarium cobalt, or any other suitable material. The second magnet 307a a may include a height (into the page in FIG. 3C) within a range of 0.25 mm to 2 mm, inclusive. In some embodiments, the second magnet 307a may include a height of 1 mm. The second magnet 307a may include a diameter within a range of 0.6 mm to 2.1 mm, inclusive. In some embodiments, the second magnet 307a may have a diameter of 1.1 mm. In other words, the inner diameter of the second magnet 307a may be configured such that the first magnet 306a may be disposed within the second magnet 307a and leave a gap between the first magnet 306a and the second magnet 307a. The gap may be about 0.1 mm, about 0.2 mm, about .3 mm, etc. according to the device layout plan. The second magnet 307a may include a Curie temperature within a range of about 180° C. to about 225° C. In some embodiments, the second magnet 307a may include a Curie temperature of 200° C. or greater.

The polarities of the first magnet 306a and the second magnet 307a may be opposite (as viewed from the top of the magnets). As seen in FIG. 3, the first magnet 306a may have a north pole axially-oriented upwards, while the second magnet 307a may have a south pole axially-oriented upwards. In other words, adjacent magnets may have different polarities. This configuration may result in a radially anisotropic magnetic field, centered about a center of the first magnet 306a. In other words, because the first magnet 306a and the second magnet 307a are coaxially aligned with varied polarity, magnetic radial anisotropy may be generated in the substrate 300 when the substrate is placed over the jig 304.

As seen in FIG. 3D, the magnetic field lines generated by the first magnet 306a and the second magnet 307a may extend upwards out of the first magnet 306a and into the second magnet 307b. In FIG. 3D, the arrows (or cones) show directionality of the magnetic field. Lighter colored arrows represent stronger field lines and darker arrows represent weaker field lines. If, for example, the location 302a is to be formed into an inductor (e.g., a toroidal inductor) with a diameter of 1 mm, the location 302a would experience a magnetic field that is radially anisotropic with a diameter of approximately 1 mm. The magnetic field may be within a range of 0.1 T to 1 T, inclusive. The strength and radial anisotropy of the magnetic field means that during a sputtering (or other deposition process such as CVV, PVD, etc.), metal may be deposited anywhere within the 1 mm radially anisotropic magnetic field to produce windings. Compared to common methods of sputtering (e.g., creating magnetic fields with a bar magnet), the metal may be deposited more efficiently, saving time, resources (e.g., space on the substrate), etc. Thus, an inductor may be formed at the location 302a that can reach power densities of about 5 A/mm² while reducing the resistance created by the deposited metals (i.e., the windings).

While the first magnets 306a-d and the second magnets 307a-d are shown as coaxially aligned concentric cylinders, other configurations are also considered. In some embodiments, the jig 304 may include radially polarized magnetic disks. The magnetic field lines may then extend away from (or towards) an axis of the magnetic disks. In another embodiment, the jig 304 may include one or more coils that carry DC current to generate radially diversifying magnetic fields. One of ordinary skill in the art would recognize many different possibilities.

At step 204, the method 200 may include providing the substrate 300 to a semiconductor processing chamber 308 on a platform 310, as shown in FIG. 3F. The semiconductor processing chamber 308 may be similar to the chamber 100 in FIG. 1. The platform 310 may be configured to support the substrate 300 and to allow magnetic fields to pass through the platform and into the substrate 300.

At step 206, the method 200 may include providing the jig 304 to the semiconductor processing chamber 308. The jig 304 may be disposed underneath the platform 310, as shown in FIG. 3F, or may be suspended above the substrate 300. The jig 304 and the substrate 300 may be provided to the semiconductor processing chamber 308 according to the device layout plan. For example, the substrate 300 and the jig 304 may be aligned such that the location 302a experiences the magnetic field generated by the first and second magnets 306a-307a. The jig 304 may be secured to the semiconductor processing chamber 308, or may be moveable.

At step 208, the method 200 may include depositing a magnetic film 312 on the substrate 300, as seen in FIG. 3F. The method 200 may also include forming vias 314a-b in the substrate 300, prior to depositing the magnetic film 312. The vias 314a may be formed using a laser, mechanical drill, or formed via an etching and/or ablation process. The vias 314a-b may include a diameter of about 10 μm, about 15 μm, about 20 μm, about 25 μm, about 30 μm, about 40 μm, about 50 μm, about 60 μm, and/or about 70 μm. In some embodiments, the vias 314a-b include the same diameter. In other embodiments, the vias 314a-b may include different diameters. The vias 314a-b may correspond to the locations of corresponding magnetic elements of the jig 304. For example, the via 314a may be centered over the first magnet 306a such that the substrate 300 experiences a radially anisotropic magnetic field centered at the via 314a.

The magnetic film 312 may be formed on multiple sides of the substrate 300. The magnetic film 312 may be formed on sidewalls of the vias 314a-b. The magnetic film 312 may be deposited to a thickness of about 10 μm, about 15 μm, about 20 μm, about 25 μm, or about 30 μm. The magnetic film 312 may include nickel, iron, cobalt, zirconia, tantalum, and/or any other suitable material. The magnetic film 312 may include a single material or may include combinations and alloys of any or all of the aforementioned materials. In some embodiments, the magnetic film 312 may be formed by sputtering one or more materials on the substrate 300. In other embodiments, the magnetic film 312 may be formed by other physical vapor deposition (PVD) techniques such as e-beam evaporation, atomic layer deposition (ALD), or any other type of deposition. In some embodiments, multiple layers of magnetic film 312 may deposited via sputtering. The multiple layers of magnetic film 312 may been interspersed with a thin oxide of a material such as zirconia, silica or others. In some embodiments, a single oxide layer may be formed on the magnetic film 312. The single oxide layer may serve as a dielectric and aid in isolating the magnetic film 312 from other layers of the inductor.

In some embodiments, the vias 314a-b and/or the magnetic film 312 may be formed prior to the jig 304 being provided to the semiconductor processing chamber 308. Foe example, the substrate 300 may have the vias 314a-b pre-fabricated. Then, the magnetic film 312 may be deposited on substrate 300 in the semiconductor processing chamber 308 without the jig 304 (e.g., to prevent interference from the magnetic elements of the jig 304).

At step 210, the method 200 may include depositing a metal layer 314 on the magnetic film 312 (or some intervening layer such as a dielectric layer), as seen in FIG. 3G. The metal layer 314 may be formed via PVD, ALD, sputtering, and/or other suitable deposition processes. The metal layer 314 may additionally or alternatively be formed via an electroplating process. For example, the metal layer 314 may be formed by depositing a metal seeding layer via PVD, then electroplating the metal layer 314 on the metal seeding layer. The metal layer 314 may be formed to a thickness of about 5 μm, about 10 μm, about 15 μm, about 20 μm, or about 30 μm.

The metal layer 314 may be formed on the top side and the bottom side of the inductor and within the vias 314a-b such that the vias 314a-b mare completely filled. The metal layer 314 may therefore form windings (e.g., a copper winding) surrounding the magnetic core (e.g., the substrate 300 and the magnetic film 312). The windings and the magnetic core may form components of the inductor (such as the inductor 200 in FIG. 3). In some embodiments, the windings may form a toroidal shape. As discussed above, a toroidal shape may provide for greater inductance and/or other performance metrics of an inductor.

The metal layer 314 may be formed via electroplating. Thick and low-resistance copper structures may be created utilizing standard plating formulations. The electroplating may utilize a current bus plane that is either deposited with PVD (e.g., sputtering) or a chemical solution processing (electroless plating). Since the current bus plane facilitates the plating of copper by acting as a seed, this plane may be referred to as a seed layer. If the seed layer is deposited by a sputtering process, the seed layer offers certain advantages with tool supply chain management as the magnetic film 312, isolation layer (e.g., an oxide layer. A dielectric layer, etc.) and seeding may be formed in the same tool or toolset at semiconductor foundry level.

At step 212, the method 200 may include dicing the substrate 300 to form semiconductor devices 316a-c. The semiconductor devices 316a-c may be inductors such as toroidal inductors. The semiconductor devices 316a-c may have a current density within a range of 4 A/mm² to 8 A/mm², inclusive. In some embodiments, the semiconductor devices 316a-c may include a current density of 5 A/mm². The semiconductor devices 316a-c may have a diameter of about 0.5 mm to about 1.5 mm. In some embodiments, the semiconductor devices 316a-c may have a diameter of 1 mm.

In some embodiments, the jig 304 may not include first and second magnets 306a-d and 307a-d. Instead, the jig 304 may include magnetic bars 318a-b (or any number of magnetic bars) arranged in a grid, as seen in FIG. 3I. The magnetic bars 318a-b may be present instead of or in addition to the vertical partitions 309a-b. The magnetic bars 318a-b may include a height within a range of 3 mm to 20 mm, inclusive. The magnetic bars 318a-b may be arranged such that such that a localized magnetic field at the substrate 300 is anisotropic at hard axis locations of the locations 302a-d. The flux generated at a crux 320 may be within a range of 100-500 Gauss, inclusive. For example, the crux 320 may be positioned underneath the location 302a such that the crux 320 aligns with the via 314a. Because the magnetic field generated at the location 302a by the magnetic bars 318a-b may optimize anisotropy, the magnetic film 312 may experience low coercivity and high permeability centered above the crux 320. In some embodiments, the local anisotropy in the film may create “hard axis” (low coercivity and high field anisotropy) properties along most of the coil path. Such local anisotropy may be created both in blanket films or films patterned into toroids, solenoids etc., or in other forms such as rectangular bars or circular frames or rectangular frames.

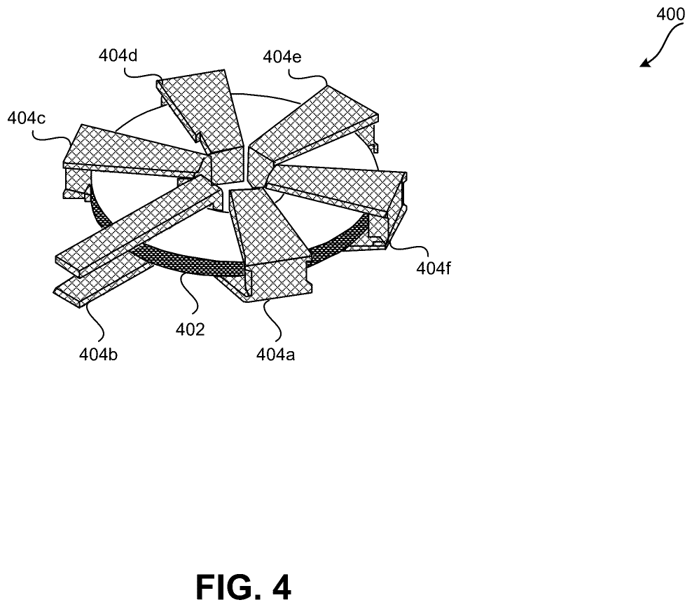

FIG. 4 illustrates a toroidal inductor 400 with six windings 404a-f, according to certain embodiments. The toroidal inductor 400 may be similar to the semiconductor device(s) 316a-c in FIG. 3 and include similar features, measurements, and capabilities. The toroidal inductor 400 may be formed by a process such as the method 200 in FIG. 2 and FIGS. 3A-2H. The toroidal inductor 400 may include a magnetic core 402 and the windings 404a-f. The magnetic core 402 may be disc-shaped and include a pathway in the center. The magnetic core 402 may be formed, in part, on a substrate and include a magnetic film, such as the substrate 300 and the magnetic film 312 in FIG. 3.

The windings 404a-f may be separated at regular radial intervals about the center of the magnetic core 402. For example, the windings 404a-f may be disposed every 60°about the magnetic core 402. One or more of the windings 404a-f (e.g., the winding 404b) may be connected to a power source (not pictured). The power source may provide an alternating current or a DC to the windings 404a-f such that the toroidal inductor 400 operates according to design (e.g., as a high switching regulator).

It should be understood that the toroidal inductor 400 is just one embodiment of devices that may be produced using the methods and systems described herein. Varying localized magnetic fields using permanent magnets (or other magnetic arrays) may produce any number of other devices, such as solenoidal inductors, capacitors, etc. One of ordinary skill in the art would recognize many different possibilities.

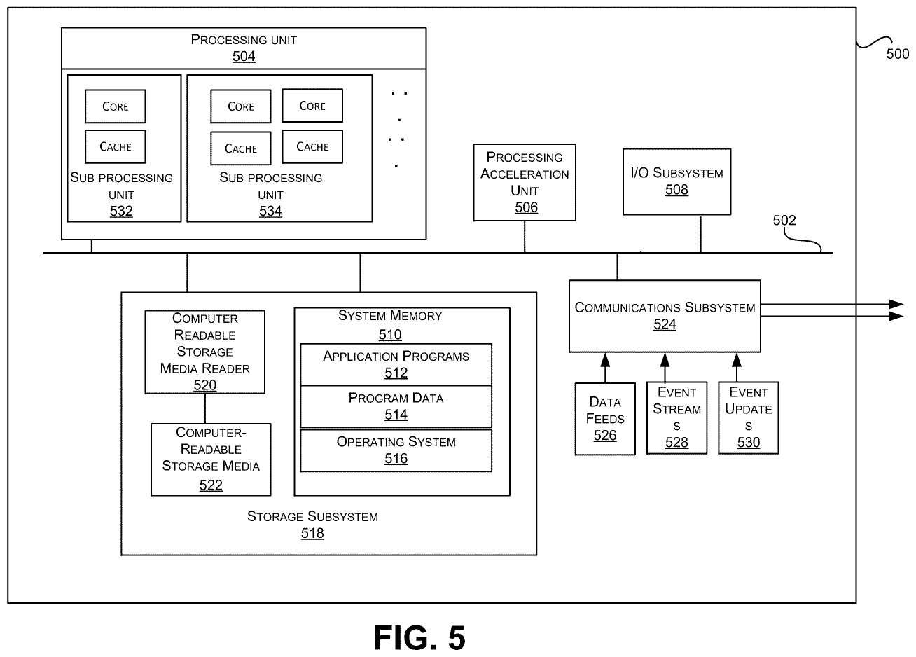

FIG. 5 illustrates an exemplary computer system 500, in which various embodiments may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices that enables users to control and interact with an input device through a natural user interface using gestures and spoken commands. Additionally, user interface input devices may include voice recognition sensing devices that enable users to interact with voice recognition systems through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that comprises software elements, shown as being currently located within a system memory 510. System memory 510 may store program instructions that are loadable and executable on processing unit 504, as well as data generated during the execution of these programs.

Depending on the configuration and type of computer system 500, system memory 510 may be volatile (such as random access memory (RAM)) and/or non-volatile (such as read-only memory (ROM), flash memory, etc.). The RAM typically contains data and/or program modules that are immediately accessible to and/or presently being operated and executed by processing unit 504. In some implementations, system memory 510 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the ROM. By way of example, and not limitation, system memory 510 also illustrates application programs 512, which may include client applications, Web browsers, mid-tier applications, relational database management systems (RDBMS), etc., program data 514, and an operating system 516.

Storage subsystem 518 may also provide a tangible computer-readable storage medium for storing the basic programming and data constructs that provide the functionality of some embodiments. Software (programs, code modules, instructions) that when executed by a processor provide the functionality described above may be stored in storage subsystem 518. These software modules or instructions may be executed by processing unit 504. Storage subsystem 518 may also provide a repository for storing data used in accordance with some embodiments.

Storage subsystem 500 may also include a computer-readable storage media reader 560 that can further be connected to computer-readable storage media 522. Together and, optionally, in combination with system memory 510, computer-readable storage media 522 may comprehensively represent remote, local, fixed, and/or removable storage devices plus storage media for temporarily and/or more permanently containing, storing, transmitting, and retrieving computer-readable information.

Computer-readable storage media 522 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 500.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD or other optical media. Computer-readable storage media 522 may include, but is not limited to, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G, 5G, or EDGE (enhanced data rates for global evolution), WiFi (IEEE 502.5 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

What is claimed is:

1. A method of forming semiconductor devices, comprising:
providing a substrate on a platform of a semiconductor processing chamber;
providing a jig underneath the platform of the semiconductor processing chamber, the jig comprising one or more magnets placed on the jig according to a device layout plan;
depositing a magnetic film on the substrate;
depositing a metal layer on the magnetic film such that the respective semiconductor devices are formed at locations on the substrate according to the device layout plan, where the locations on the substrate experience a radially anisotropic magnetic field from at least one of the one or more magnets; and
dicing the substrate according to the device layout plan such that the respective semiconductor devices are formed.

2. The method of claim 1, wherein the magnetic fields are within a range of 0.25 T to 1.25 T, inclusive.

3. The method of claim 1, wherein the magnetic fields of adjacent magnets of the one or more magnets have alternating polarity.

4. The method of claim 1, further comprising forming a magnetic film on the substrate.

5. The method of claim 4, wherein the magnetic film is used as a blanket unpatterned film.

6. The method of claim 4, wherein the magnetic film patterned as circular or rectangular frames.

7. The method of claim 1, wherein the one or more magnets comprise at least one or neodymium iron boron, samarium cobalt, or Alnico.

8. A semiconductor manufacturing jig, comprising:
a bottom surface;
a plurality of vertical partitions, attached to the bottom surface and defining one or more recesses corresponding to locations of semiconductor devices to be formed according to a device layout plan; and
one or more magnets disposed in respective recesses of the one or more recesses corresponding to locations of semiconductor devices according to a device layout plan, wherein the one or more magnets produce respective magnetic fields on a substrate placed on the plurality of vertical partitions, the respective magnetic fields corresponding to the locations of the semiconductor devices to be formed.

9. The semiconductor manufacturing jig of claim 8, wherein the respective magnetic fields produce local anisotropy at each of the locations of semiconductor devices to be formed on the substrate.

10. The semiconductor manufacturing jig of claim 8, wherein the respective magnetic fields produce radial anisotropy at each of the locations of semiconductor devices to be formed on the substrate.

11. The semiconductor manufacturing jig of claim 8, wherein the one or more magnets have a Curie temperature of at least 200 °C.

12. The semiconductor manufacturing jig of claim 8, wherein the one or more magnets are cylindrical.

13. The semiconductor manufacturing jig of claim 12, wherein the one or more magnets are hollow.

14. The semiconductor manufacturing jig of claim 8, wherein the one or magnets are arranged in the jig coaxially.

15. The semiconductor manufacturing jig of claim 8, wherein the one or magnets are arranged in the jig such that polarities of adjacent magnets are different.

16. A toroidal inductor, comprising:
a substrate;
a magnetic film deposited on the substrate during a manufacturing process, wherein the substrate is exposed to one or more magnetic fields creating locally and/or spatially-variant anisotropy; and
one or more metal windings deposited on the substrate corresponding to the spatially-variant anisotropy.

17. The toroidal inductor of claim 16, further comprising a cobalt-zirconium-tantalum (CZT) layer.

18. The toroidal inductor of claim 16, wherein a current density of the toroidal inductor is in a range of 1-5 A/mm², inclusive.

19. The toroidal inductor of claim 16, wherein the substrate comprises silicon.

20. The toroidal inductor of claim 16, wherein the locally and/or spatially variant anisotropy is generated at least in part by a magnetic grid.
